(19) United States
(12) Patent Application Publication
(10) Pub. No.: US 2021/0063025 A1
(43) Pub. Date: Mar. 4, 2021

(54) METHOD AND SYSTEM FOR PROTECTING A SINGLE-STAGE FURNACE IN A MULTI-ZONE SYSTEM

(71) Applicant: Lennox Industries Inc., Richardson, TX (US)

(72) Inventors: Robert B. USELTON, Plano, TX (US); Matthew S. RIEPENHOFF, Lewisville, TX (US)

(73) Assignee: Lennox Industries Inc., Richardson, TX (US)

(21) Appl. No.: 16/556,545

(22) Filed: Aug. 30, 2019

(51) Int. Cl. F24D 19/10; F24D 5/10; F24D 19/00; F24H 3/02

(52) U.S. Cl. CPC F24D 19/1084; F24H 3/025; F24D 19/0056; F24D 5/10

(57) ABSTRACT

A method of protecting a single-stage furnace in a multi-zone system includes monitoring a temperature of each zone of a plurality of zones, determining if the temperature of at least one zone of the plurality of zones is less than a threshold temperature, powering on the HVAC system to satisfy a heating demand of the zone having a temperature less than the threshold temperature, monitoring an outlet temperature of the single-stage furnace, determining if the outlet temperature is greater than an outlet temperature threshold, and responsive to a determination that the outlet temperature is greater than the outlet temperature threshold, modulating a gas valve to reduce a flow of gas to the single-stage furnace.

### TECHNICAL FIELD

The present invention relates generally to a heating, ventilation, and air conditioning systems (HVAC) and more particularly, but not by way of limitation, to a system and method for protecting a single-stage furnace in a multi-zone system.

### BACKGROUND

HVAC systems can be configured as single-zone systems or multi-zone systems. A single-zone system has an enclosed space with only one zone. In a single-zone system, the entire enclosed space is supplied with conditioned air when HVAC system is operating. A multi-zone system has an enclosed space that is divided into a plurality of zones. In a multi-zone system, the HVAC system can supply conditioned air to one zone of the plurality of zones, multiple zones of the plurality of zones, or all of the zones of the plurality of zones. The HVAC system directs conditioned air to the zone(s) with a heating or cooling demand using one or more dampers positioned within air ducts of the HVAC system. For example, a two-story home may be divided into an upstairs zone and a downstairs zone. Situations may arise where there is a heating or cooling demand in only one of the two zones. In these situations, the HVAC system may supply conditioned air to only the zone that needs the conditioned air. For example, the downstairs zone may have a heating demand while the upstairs zone does not. The HVAC system can supply heated air to only the downstairs zone.

Multi-zone systems allow for more granular control of the heating and cooling demands of an enclosed space compared to single-zone systems as conditioned air can be supplied to only those zones that have a heating or cooling demand. However, conventional multi-zone HVAC systems are typically more expensive than conventional single-zone systems. Conventional multi-zone HVAC systems are often more expensive because they include more complicated components like multi-stage furnaces. Multi-stage furnaces allow greater flexibility in the amount of heat generated so that the HVAC system can more efficiently and safely provide heated air to the plurality of zones of the multi-zone system. For example, if only one zone of the multi-zone system has a heating demand, the multi-stage furnace can be configured to operate using only a single stage of its multiple stages. If all zones of the multi-zone system have a heating demand, the multi-stage furnace can be configured to operate using all of its stages to provide maximum heating capability.

In an effort to reduce costs, home builders often fit homes with single-zone HVAC systems with less expensive components, such as single-stage furnaces. Sometimes the purchaser of the home requests that the house be configured for multi-zone use. In these instances, the home builder can retroactively add in components to allow the single-zone HVAC system with a single-stage furnace to operate as a multi-zone system. Using a single-stage furnace in a multi-zone system can be problematic when heating demands are low, such as when only a single zone of a multi-zone system has a heating demand. When fewer than all of the plurality of zones of a multi-zone system have a heating demand, air flow through the HVAC system is reduced. The reduced airflow can result in the HVAC system overheating the single-stage furnace as there is less air for the single-stage burner to exchange heat with and the single-stage furnace cannot adjust its heat output like a multi-stage furnace can. If the air exiting the HVAC system reaches temperatures that exceed a safety limit, also referred to as the outlet temperature threshold, the HVAC system automatically shuts down to prevent damage to the HVAC system. If the HVAC system shuts down multiple times, the HVAC system may initiate a lock-out that can only be overridden by a maintenance technician.

### BRIEF SUMMARY OF THE INVENTION

An illustrative method of protecting a single-stage furnace in a multi-zone system includes monitoring a temperature of each zone of a plurality of zones, determining if the temperature of at least one zone of the plurality of zones is less than a threshold temperature, powering on the HVAC system to satisfy a heating demand of the zone having a temperature less than the threshold temperature, monitoring an outlet temperature of the single-stage furnace, determining if the outlet temperature is greater than an outlet temperature threshold, and, responsive to a determination that the outlet temperature is greater than the outlet temperature threshold, modulating a gas valve to reduce a flow of gas to the single-stage furnace.

An illustrative method of protecting a single-stage furnace in a multi-zone HVAC system includes monitoring an outlet temperature of the single-stage furnace, determining if the outlet temperature is greater than an outlet temperature threshold, and, responsive to a determination that the outlet temperature is greater than the outlet temperature threshold, modulating a gas valve to reduce a flow of gas to the single-stage furnace.

An illustrative single-stage furnace protection system includes an indoor unit with a single-stage combustion air blower configured to provide heated air to an air duct, an adjustable gas valve, a burner coupled to the adjustable gas valve, a blower coupled to the air duct and configured to move air therethrough, a temperature sensor positioned proximal to an outlet of the single-stage furnace, and an HVAC controller in communication with the adjustable gas valve. The HVAC controller is operable to implement a method that includes monitoring an outlet temperature of the single-stage furnace, determining if the outlet temperature is greater than an outlet temperature threshold, and responsive to a determination that the outlet temperature is greater than the outlet temperature threshold, modulating a gas valve to reduce a flow of gas to the single-stage furnace.

### BRIEF DESCRIPTION OF THE DRAWINGS

FIG. 1 is a block diagram of an illustrative HVAC system;

FIG. 2 is a schematic illustrating a configuration of an HVAC system according to aspects of the disclosure; and

FIG. 3 illustrates a method of protecting a single-stage furnace in a multi-zone system according to aspects of the disclosure.

### DETAILED DESCRIPTION OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

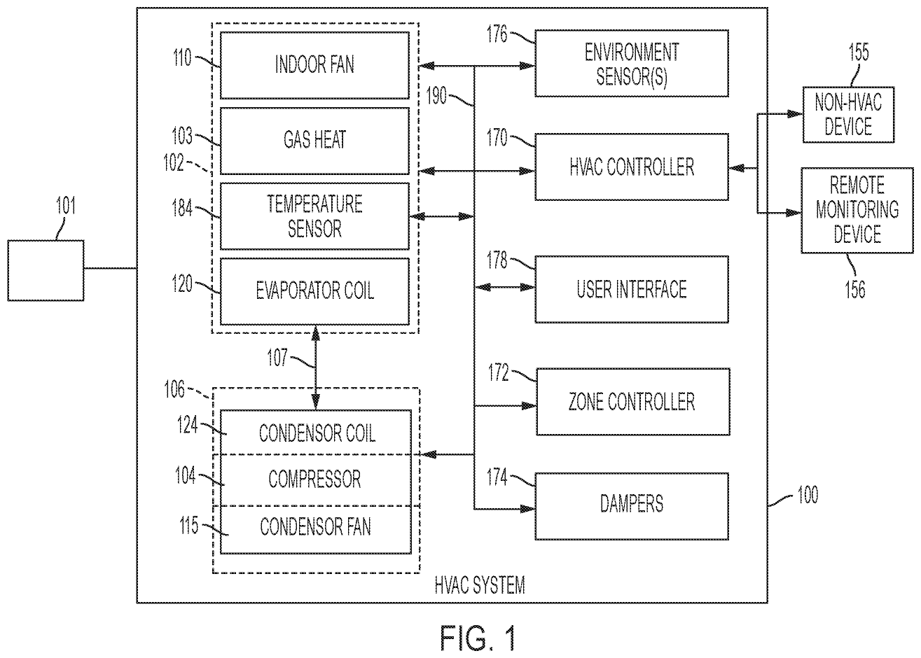

FIG. 1 illustrates an HVAC system 100. HVAC system 100 is configured to condition air via, for example, heating, cooling, humidifying, or dehumidifying air within an enclosed space 101. In a typical embodiment, enclosed space 101 is, for example, a house, an office building, a warehouse, and the like. Thus, HVAC system 100 can be a residential system or a commercial system such as, for example, a rooftop system. HVAC system 100 includes various components; however, in other embodiments. HVAC system 100 may include additional components that are not illustrated but typically included within HVAC systems.

HVAC system 100 includes an indoor fan 110, a gas heat 103 typically associated with indoor fan 110, and an evaporator coil 120, also typically associated with indoor fan 110. For the purposes of this disclosure, gas heat 103 is a single-stage gas furnace. Indoor fan 110, gas heat 103, and evaporator coil 120 are collectively referred to as an indoor unit 102. In a typical embodiment, indoor unit 102 is located within, or in close proximity to, enclosed space 101. HVAC system 100 also includes a compressor 104, an associated condenser coil 124, and an associated condenser fan 115, which are collectively referred to as an outdoor unit 106. In various embodiments, outdoor unit 106 and indoor unit 102 are, for example, a rooftop unit or a ground-level unit. In various embodiments, outdoor unit 106 and indoor unit 102 may be separated in a split system or may be combined in a single-package unit. Compressor 104 and the associated condenser coil 124 are connected to evaporator coil 120 by a refrigerant line 107. Refrigerant line 107 includes, for example, a plurality of copper pipes that connect the associated condenser coil 124 and compressor 104 to the evaporator coil 120. Compressor 104 may be, for example, a single-stage compressor, a multi-stage compressor, a single-speed compressor, or a variable-speed compressor. Indoor fan 110, sometimes referred to as a blower, is configured to operate at different capacities (e.g., variable motor speeds) to circulate air through HVAC system 100, whereby the circulated air is conditioned and supplied to enclosed space 101.

Still referring to FIG. 1, HVAC system 100 includes an HVAC controller 170 is configured to control operation of the various components of HVAC system 100 such as, for example, indoor fan 110, gas heat 103, and compressor 104 to regulate the environment of enclosed space 101. In some embodiments, HVAC system 100 can be a zoned system. HVAC system 100 includes a zone controller 172, dampers 174, and a plurality of environment sensors 176. In a typical embodiment, HVAC controller 170 cooperates with the zone controller 172 and the dampers 174 to regulate the environment of enclosed space 101.

HVAC controller 170 may be an integrated controller or a distributed controller that directs operation of HVAC system 100. HVAC controller 170 includes an interface to receive, for example, thermostat calls, temperature setpoints, blower control signals, environmental conditions, and operating mode status for various zones of HVAC system 100. The environmental conditions may include indoor temperature and relative humidity of enclosed space 101. In a typical embodiment, HVAC controller 170 also includes a processor and a memory to direct operation of HVAC system 100 including, for example, a speed of the indoor fan 110.

Still referring to FIG. 1, in some embodiments, the plurality of environment sensors 176 are associated with HVAC controller 170 and also optionally associated with a user interface 178. The plurality of environment sensors 176 provides environmental information within a zone or zones of enclosed space 101 such as, for example, temperature and/or humidity of enclosed space 101 to HVAC controller 170. The plurality of environment sensors 176 may also send the environmental information to a display of user interface 178. In some embodiments, user interface 178 provides additional functions such as, for example, operational, diagnostic, status message display, and a visual interface that allows at least one of an installer, a user, a support entity, and a service provider to perform actions with respect to HVAC system 100. In some embodiments, user interface 178 is, for example, a thermostat. In other embodiments, user interface 178 is associated with at least one sensor of the plurality of environment sensors 176 to determine the environmental condition information and communicate that information to the user. User interface 178 may also include a display, buttons, a microphone, a speaker, or other components to communicate with the user. Additionally, user interface 178 may include a processor and memory configured to receive user-determined parameters such as, for example, a relative humidity of enclosed space 101 and to calculate operational parameters of HVAC system 100 as disclosed herein.

HVAC system 100 is configured to communicate with a plurality of devices such as, for example, a monitoring device 156, a communication device 155, and the like. In a typical embodiment, and as shown in FIG. 1, monitoring device 156 is not part of HVAC system 100. For example, monitoring device 156 is a server or computer of a third party such as, for example, a manufacturer, a support entity, a service provider, and the like. In some embodiments, monitoring device 156 is located at an office of, for example, the manufacturer, the support entity, the service provider, and the like.

In a typical embodiment, communication device 155 is a non-HVAC device having a primary function that is not associated with HVAC systems. For example, non-HVAC devices include mobile-computing devices configured to interact with HVAC system 100 to monitor and modify at least some of operating parameters of HVAC system 100. Mobile computing devices may be, for example, a personal computer (e.g., desktop or laptop), a tablet computer, a mobile device (e.g., smart phone), and the like. In a typical embodiment, communication device 155 includes at least one processor, memory, and a user interface such as a display. One skilled in the art will also understand that communication device 155 disclosed herein includes other components that are typically included in such devices including, for example, a power supply, a communications interface, and the like.

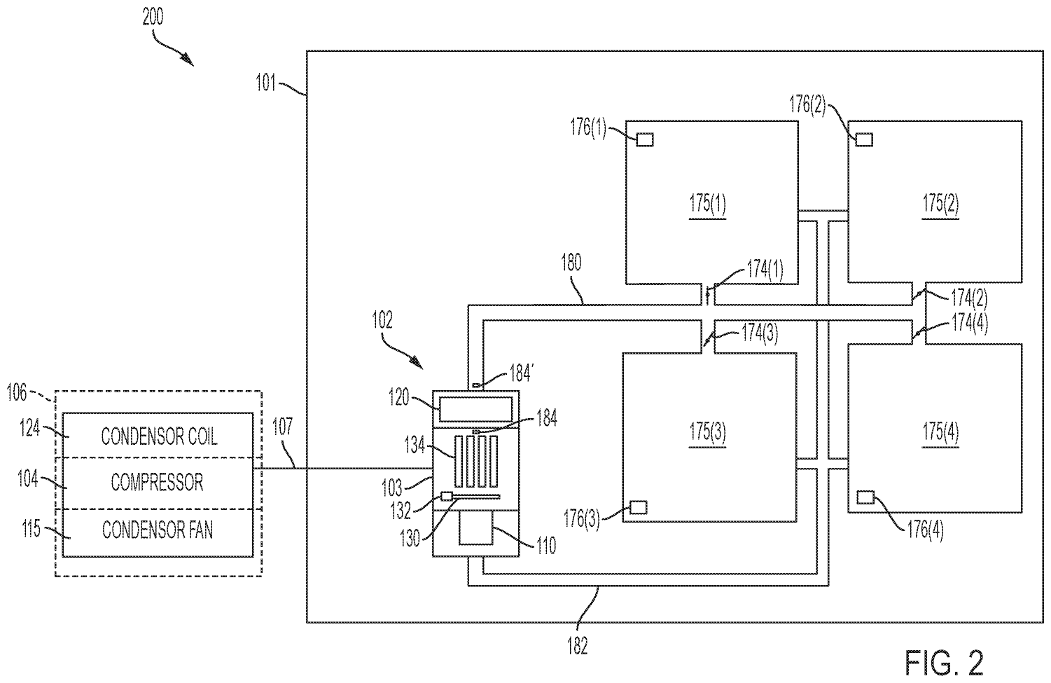

Zone controller 172 is configured to manage movement of conditioned air to designated zones of enclosed space 101. Each of the designated zones includes at least one conditioning or demand unit such as, for example, gas heat 103 and user interface 178, only one instance of user interface 178 being expressly shown in FIG. 1, such as, for example, the thermostat. HVAC system 100 allows the user to independently control the temperature in the designated zones (e.g., zones 175(1)-(4) shown in FIG. 2). In a typical embodiment, zone controller 172 operates dampers 174 to control air flow to the zones of enclosed space 101.

A data bus 190, which in the illustrated embodiment is a serial bus, couples various components of HVAC system 100 together such that data is communicated therebetween. Data bus 190 may include, for example, any combination of hardware, software embedded in a computer readable medium, or encoded logic incorporated in hardware or otherwise stored (e.g., firmware) to couple components of HVAC system 100 to each other. As an example and not by way of limitation, the data bus 190 may include an Accelerated Graphics Port (AGP) or other graphics bus, a Controller Area Network (CAN) bus, a front-side bus (FSB), a HYPERTRANSPORT (HT) interconnect, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. In various embodiments, the data bus 190 may include any number, type, or configuration of data buses 190, where appropriate. In particular embodiments, one or more data buses 190 (which may each include an address bus and a data bus) may couple HVAC controller 170 to other components of HVAC system 100. In other embodiments, connections between various components of HVAC system 100 are wired. For example, conventional cable and contacts may be used to couple HVAC controller 170 to the various components. In some embodiments, a wireless connection is employed to provide at least some of the connections between components of HVAC system 100 such as, for example, a connection between HVAC controller 170 and indoor fan 110 or the plurality of environment sensors 176.

FIG. 2 is a schematic illustrating a multi-zone system 200 that includes HVAC system 100 of FIG. 1 and zones 175(1)-(4). FIG. 2 is discussed herein relative to FIG. 1. Indoor unit 102 includes gas heat 103. Gas heat 103 is a single-stage furnace that includes a burner 130, a gas valve 132, and a heat exchanger 134. In some aspects, gas heat 103 includes a single-stage combustion air blower. Gas valve 132 is an adjustable flow gas valve. In some embodiments, gas valve 132 is a two-stage gas valve having a low flow rate and a high flow rate. In other embodiments, gas valve 132 may be a multi-stage or variable-stage (e.g., continuously variable) gas valve. Gas valve 132 supplies gas to burner 130 for combustion. Heat generated by burner 130 is exchanged with air from zones 175(1)-(4) via heat exchanger 134. Indoor fan 110 circulates air between zones 175(1)-(4) and indoor unit 102 via an air duct 180 and a return air duct 182.

Each zone of zones 175(1)-(4) may be, for example, a room or section of a residential or commercial building. Each of zones 175(1)-(4) receives conditioned air from indoor unit 102 via air duct 180. Dampers 174(1)-(4) are positioned within air duct 180 to selectively allow conditioned air from indoor unit 102 to be directed to one or more of zones 175(1)-(4). Each zone 175(1)-(4) includes an environment sensor 176(1)-(4), respectively, that monitors conditions (e.g., temperature, humidity, etc.) within zones 175(1)-(4). Return air duct 182 returns air from zones 175(1)-(4) to indoor unit 102.

HVAC controller 170 monitors conditions in each of zones 175(1)-(4). In some embodiments, multi-zone system 200 monitors temperatures in each of zones 175(1)-(4). For example, when HVAC controller 170 detects that the temperature of zone 175(1) exceeds a threshold temperature (e.g., a setpoint temperature), HVAC controller 170 turns HVAC system 100 on to supply heated or cooled air to satisfy the demand for zone 175(1). In this example, zone controller 172 opens damper 174(1) and closes dampers 174(2)-(4). With only damper 174(1) open, airflow through indoor unit 102 is reduced. Conventional HVAC systems with single-stage furnaces tend to overheat when supplying heated air to less than all of the zones in a multi-zoned system. The reduced airflow through indoor unit 102 results in elevated temperatures at the discharge of indoor unit 102. If the discharge temperature reaches a threshold value (e.g., 160° F.), HVAC controller 170 shuts down HVAC system 100 for safety. Once temperatures within indoor unit 102 have cooled down, HVAC controller 170 may restart HVAC system 100 to again attempt to supply heated air to zone 175(1) to satisfy the heating demand. If the discharge temperature of indoor unit 102 again rises to the threshold value from lack of air flow, HVAC controller 170 again shuts down HVAC system 100. The elevated temperatures of the example discussed above are undesirable for several reasons. As an initial matter, the elevated temperatures can damage components of indoor unit 102. Additionally, some HVAC systems will lock out gas heat 103 after repeated shut downs. When gas heat 103 becomes locked out, a service call is needed to examine and reset the system.

One conventional solution to avoid the lock-out problem is to use a multi-stage furnace. While multi-stage furnaces can avoid the lock-out problem described above, they are more expensive than single-stage furnaces. This disclosure is directed to avoiding the lock-out problem when using single-stage furnaces in multi-zone systems.

In order to avoid situations where gas heat 103 becomes locked out, HVAC system 100 monitors a temperature of air leaving indoor unit 102. In some embodiments, a temperature sensor 184 is included in indoor unit 102. In one embodiment, temperature sensor 184 is positioned at an outlet of gas heat 103. In another embodiment, temperature sensor 184′ is positioned in the inlet to air duct 180. Temperature sensors 184, 184′ may be implemented in various ways, such as thermistors, resistance temperature detectors, thermocouples, and the like. In the example discussed above where HVAC controller 170 determines that zone 175(1) has a heating demand, damper 174(1) is open and dampers 174(2)-(4) are closed. With only damper 174(1) open, airflow to indoor unit 102 is reduced. HVAC controller 170 monitors the temperature of air leaving indoor unit 102. HVAC controller 170 monitors the temperature of the air leaving indoor unit 102 via temperature sensor 184 or temperature sensor 184′. If the temperature of the air leaving indoor unit 102 begins to increase toward the outlet temperature threshold, HVAC controller 170 reduces gas flow from gas valve 132 to reduce the amount of heat generated by burner 130 so that the outlet temperature threshold is never reached to avoid HVAC system 100 from shutting down. Similarly, HVAC controller 170 can increase flow from gas valve 132 to increase the amount of heat generated by burner 130. For example, if HVAC controller 170 determines that one or more additional zones of the plurality of zones 175(2)-(4) also have heating demands. HVAC controller 170 can increase the flow of gas from gas valve 132 if the temperature of the air leaving indoor unit 102 begins to fall as a result of the increased airflow.

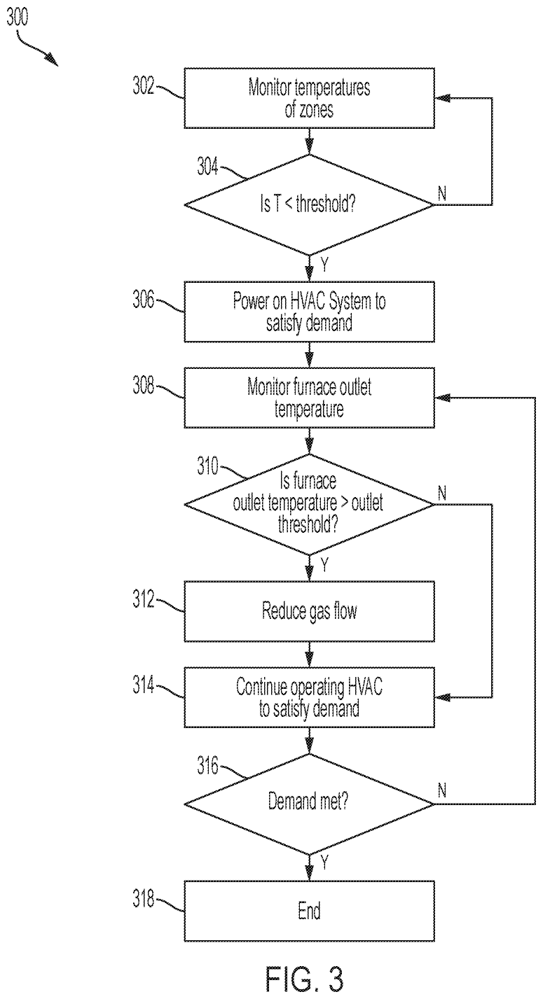

FIG. 3 is a flowchart illustrating a method 300 of protecting a single-stage furnace in a multi-zone system according to aspects of the disclosure. Method 300 is discussed relative to FIGS. 1 and 2. Method 300 begins at step 302. In step 302, HVAC controller 170 monitors a temperature of zones 175(1)-(4) to determine if there is a heating demand in any of zones 175(1)-(4). For example, HVAC controller 170 monitors environment sensors 176(1)-(4) to determine a temperature in each of zones 175(1)-(4). After step 302, method 300 proceeds to step 304.

In step 304, HVAC controller 170 compares the temperatures of zones 175(1)-(4) relative to threshold temperatures for each of zones 175(1)-(4). The threshold temperature may be, for example, a setpoint temperature that indicates a desired temperature for each zone of the plurality of zones 175(1)-(4). Setpoint or temperature setpoint refers to a target temperature setting of HVAC system 100 as set by a user or automatically based on a pre-defined schedule. By way of example, the threshold temperature may be 70° F. If HVAC controller 170 determines that any of the temperatures indicated by environment sensors 176(1)-(4) are below the threshold temperature, method 300 proceeds to step 306. If HVAC controller 170 determines that none of the temperatures indicated by environment sensors 176(1)-(4) are below the threshold temperature, method 300 returns to step 302 to continue to monitor for a heating demand.

In step 306, HVAC controller 170 powers on HVAC system 100 to satisfy the heating demand. HVAC controller 170 also controls dampers 174(1)-(4) to direct air only to the zone of the plurality of zones 175(1)-(4) that has a heating demand. Method 300 then proceeds to step 308. In step 308, HVAC controller 170 monitors the temperature at the outlet of gas heat 103. For example, HVAC controller 170 can monitor the outlet temperature via temperature sensor 184 or 184′. Method 300 then proceeds to step 310.

In step 310, HVAC controller 170 compares the outlet temperature of gas heat 103 to an outlet temperature threshold. The outlet temperature threshold is the highest allowable outlet temperature of gas heat 103 before HVAC controller 170 reduces the amount of gas supplied to burner 130 to reduce the amount of heat generated by burner 130. The outlet temperature threshold is selected to be a temperature less than a shut-off temperature threshold. The shut-off temperature threshold is the temperature at which HVAC system 100 will automatically shut off for safety. A focus of method 300 is to lower the outlet temperature of gas heat 103 before it reaches the shut-off temperature threshold. Selecting an outlet temperature threshold that is sufficiently below the shut-off temperature threshold prevents the outlet temperature of gas heat 103 from reaching the shut-off temperature threshold and thus prevents HVAC system 100 from automatically shutting down in response to elevated temperatures. For example, the shut-off temperature threshold may be 160° F. and the outlet threshold may be 140° F. Responsive to a determination by HVAC controller 170 that the outlet temperature of gas heat 103 is greater than the outlet temperature threshold, method 300 proceeds to step 312. Responsive to a determination by HVAC controller 170 that the outlet temperature of gas heat 103 is less than the outlet temperature threshold, method 300 proceeds to step 314.

In step 312, HVAC controller 170 modulates the flow of gas by reducing an amount of gas provided to burner 130. For example, HVAC controller 170 actuates gas valve 132 to reduce the flow of gas through gas valve 132. Gas valve 132 may be a multi-stage gas valve having two or more flow rates or variable-stage gas valve (e.g., continuously variable). Reducing the flow of gas through gas valve 132 reduces the amount of gas provided to burner 130, and thus reduces the amount of heat generated by burner 130. The reduction in heat generated by burner 130 reduces the outlet temperature of gas heat 103. In some aspects, HVAC controller 170 monitors the outlet temperature of gas heat 103 to determine if the outlet temperature of gas heat 103 falls below a low temperature threshold (e.g., below 120°. If the temperature drops below the low temperature threshold, HVAC controller 170 increases the flow of gas to burner 130 to keep the outlet temperature of gas heat 103 between about 120° F. and 140° F. After step 312, method 300 proceeds to step 314.

In step 314, HVAC system 100 continues to run to satisfy the heating demand. Method 300 then proceeds to step 316. In step 316, HVAC controller 170 monitors the temperature of zones 175(1)-(4) to determine if the heating demand has been satisfied. Responsive to a determination by HVAC controller 170 that the heating demand has not been satisfied, method 300 returns to step 308. Responsive to a determination by HVAC controller that the demand has been satisfied, method 300 proceeds to step 318 and method 300 ends.

In this patent application, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Python, Java, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method of protecting a single-stage furnace in a multi-zone system, the method comprising:
monitoring, by an HVAC controller of an HVAC system, a temperature of each zone of a plurality of zones;
determining, by the HVAC controller, if the temperature of at least one zone of the plurality of zones is less than a threshold temperature;
responsive to a determination that the temperature of at least one zone of the plurality of zones is less than the threshold temperature, powering on the HVAC system to satisfy a heating demand of the zone having a temperature less than the threshold temperature;
monitoring, by the HVAC controller, an outlet temperature of the single-stage furnace;
determining, by the HVAC controller, if the outlet temperature is greater than an outlet temperature threshold; and
responsive to a determination that the outlet temperature is greater than the outlet temperature threshold, modulating a gas valve to reduce a flow of gas to the single-stage furnace.

2. The method of claim 1, comprising:
determining, by the HVAC controller, if the heating demand has been satisfied; and
responsive to a determination that the heating demand has not been satisfied, returning to the monitoring step.

3. The method of claim 1, wherein the powering on the HVAC system comprises adjusting a damper to direct a flow of conditioned air in the HVAC system to the at least one zone of the plurality of zones having a temperature less than the threshold temperature.

4. The method of claim 1, wherein the monitoring the outlet temperature of the single-stage furnace comprises reading a temperature of a temperature sensor positioned at an outlet of the single-stage furnace.

5. The method of claim 1, wherein the monitoring the outlet temperature of the single-stage furnace comprises reading a temperature of a temperature sensor positioned in an air duct coupled to an outlet of the single-stage furnace.

6. The method of claim 1, wherein the gas valve is a two-stage gas valve with a low-flow rate and a high-flow rate.

7. The method of claim 1, wherein the gas valve is a variable-stage gas valve with a variable flow rate.

8. A method of protecting a single-stage furnace in a multi-zone HVAC system, the method comprising:
monitoring, by an HVAC controller of the multi-zone HVAC system, an outlet temperature of the single-stage furnace;
determining, by the HVAC controller, if the outlet temperature is greater than an outlet temperature threshold; and
responsive to a determination that the outlet temperature is greater than the outlet temperature threshold, modulating a gas valve to reduce a flow of gas to the single-stage furnace.

9. The method of claim 8, comprising:
determining, by the HVAC controller, if a heating demand of the multi-zone HVAC system has been satisfied; and
responsive to a determination that the heating demand has not been satisfied, returning to the monitoring step.

10. The method of claim 8, comprising adjusting a damper to direct a flow of conditioned air in the multi-zone HVAC system to a zone of the multi-zone HVAC system having a temperature less than a threshold temperature.

11. The method of claim 8, wherein the monitoring the outlet temperature of the single-stage furnace comprises reading a temperature of a temperature sensor positioned at an outlet of the single-stage furnace.

12. The method of claim 8, wherein the monitoring the outlet temperature of the single-stage furnace comprises reading a temperature of a temperature sensor positioned in an air duct coupled to an outlet of the single-stage furnace.

13. The method of claim 8, wherein the gas valve is a two-stage gas valve with a low-flow rate and a high-flow rate.

14. The method of claim 8, wherein the gas valve is a variable-stage gas valve with a variable flow rate.

15. A single-stage furnace protection system comprising:
an indoor unit comprising:
a single-stage furnace configured to provide heated air to an air duct;
an adjustable gas valve; and
a burner coupled to the adjustable gas valve;
a blower coupled to the air duct and configured to move air therethrough;
a temperature sensor positioned proximal to an outlet of the single-stage furnace; and
an HVAC controller in communication with the adjustable gas valve;
wherein the HVAC controller is configured to:
monitor an outlet temperature of the single-stage furnace;
determine if the outlet temperature is greater than an outlet temperature threshold; and
responsive to a determination that the outlet temperature is greater than the outlet temperature threshold, modulating a gas valve to reduce a flow of gas to the single-stage furnace.

16. The single-stage furnace protection system of claim 15, wherein the gas valve is a two-stage gas valve with a low-flow rate and a high-flow rate.

17. The single-stage furnace protection system of claim 15, wherein the HVAC controller is configured to:
determine if a heating demand has been satisfied; and
responsive to a determination that the heating demand has not been satisfied, monitor the outlet temperature of the single-stage furnace a second time.

18. The single-stage furnace protection system of claim 15, wherein the HVAC controller is configured to adjust a damper to direct a flow of conditioned air in the single-stage furnace protection system to a zone of the single-stage furnace protection system having a temperature less than a threshold temperature.

19. The single-stage furnace protection system of claim 15, wherein the adjustable gas valve is a two-stage gas valve with a low-flow rate and a high-flow rate.

20. The single-stage furnace protection system of claim 15, wherein the adjustable gas valve is a variable-stage gas valve with a variable flow rate.
